(19) United States
(12) Patent Application Publication
(10) Pub. No.: US 2025/0046878 A1
(43) Pub. Date: Feb. 6, 2025

(54) Electrolytes for Fast-Charging and Low-Temperature Lithium Ion Batteries

(71) Applicant: University of Utah Research Foundation, Salt Lake City, UT (US)

(72) Inventors: Tao GAO, Salt Lake City, UT (US); Zongjian LI, Salt Lake City, UT (US)

(21) Appl. No.: 18/787,550

(22) Filed: Jul. 29, 2024

Related U.S. Application Data
(60) Provisional application No. 63/516,420, filed on Jul. 28, 2023.

(51) Int. Cl. H01M 10/0569; H01M 4/133; H01M 4/136; H01M 10/0525; H01M 10/0568

(52) U.S. Cl. CPC H01M 10/0569; H01M 4/133; H01M 4/136; H01M 10/0525; H01M 10/0568; H01M 2300/0042

(57) ABSTRACT

Lithium ion batteries and liquid electrolytes for lithium ion batteries are described. An example lithium ion battery can include a cathode, an anode, and a liquid electrolyte in contact with the cathode and the anode. The anode can allow reversible intercalation of lithium ions into the anode. The liquid electrolyte can include a single-oxygen linear ether solvent and a lithium salt at least partially dissolved in the solvent. The lithium salt can include a sulfur-fluorine bond.

### CROSS REFERENCE TO RELATED APPLICATIONS

This application claims priority to U.S. Provisional Patent Application No. 63/516,420, filed Jul. 28, 2023, which is hereby incorporated herein by reference.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION BY REFERENCE STATEMENT

Not applicable.

### BACKGROUND

With the proliferation of electric vehicles, next-generation lithium-ion batteries (LIBs) are sought to achieve both fast charging and low-temperature operation. As a component in LIBs, the electrolyte influences the electrode-electrolyte interfacial properties and the bulk transport properties, thereby affecting LIB performance. Due to their reasonable polarity, low viscosity and good cathodic stability, ether solvents have been used in Li metal batteries (Li/S, Li/air etc.). However, ether solvents often cause undesired intercalation in electrodes of LIBs. Because of this, ether solvents are seldom used in LIBs.

### SUMMARY

This disclosure relates to lithium ion batteries that include single-oxygen linear ether (SOLE) based electrolytes for fast-charging and low-temperature operation. In one example, a lithium ion battery can include a cathode, an anode, and a liquid electrolyte in contact with the cathode and anode. The anode can allow reversible intercalation of lithium ions into the anode. The liquid electrolyte can include a single-oxygen linear ether solvent and a lithium salt at least partially dissolved in the solvent. The lithium salt can include a sulfur-fluorine bond.

In another example, a liquid electrolyte for a lithium ion battery can include a single-oxygen linear ether solvent that is selected from the group consisting of: methyl butyl ether (MBE), ethyl propyl ether (EPE), ethyl butyl ether (EBE), tert-butyl methyl ether (TBME), tert-butyl ethyl ether (TBEE), and combinations thereof. A lithium salt can be at least partially dissolved in the solvent. The lithium salt can include a sulfur-fluorine bond.

In another example, a method of using a lithium ion battery can include charging or discharging the lithium ion battery. The lithium ion battery can include a cathode, an anode, and a liquid electrolyte in contact with the cathode and the anode. The anode can allow reversible intercalation of lithium ions into the anode. The liquid electrolyte can include a single-oxygen linear ether solvent and a lithium salt at least partially dissolved in the solvent. The lithium salt can include a sulfur-fluorine bond.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a schematic view of an example lithium ion battery in accordance with an example of the present technology.

FIG. 2 is a graph of melting point and boiling point of several SOLE solvents and other solvents.

FIG. 3 is graph of dielectric constant and dipole of several SOLE solvents and other solvents.

FIG. 4 is a graph of conductivity of several SOLE solvents and other solvents.

FIG. 5 shows Raman spectroscopy of SOLE electrolytes based on MBE, EBE and DPE

FIG. 6A-6C shows schematics of solvation shells (SSIP, CIP, AGG) of Li⁺ in the liquid electrolytes.

FIG. 7 shows a breakdown of the electrolyte structure in several SOLE electrolytes and other electrolytes (free anion, CIPs, AGGs).

FIG. 8A-8D shows Raman spectra of 1 m LiFSI in (A) MBE; (B) EPE; (C) DPE; and (D) TBME.

FIG. 9 shows the coordination number of different SOLE electrolytes (the results were calculated from the Raman spectra results).

FIG. 10 shows 002 peaks of XRD patterns of intercalated graphite, which is intercalated in Glyme, MBE and LP71. The pristine graphite set as control.

FIG. 11 shows 004 peaks of XRD patterns of intercalated graphite, which is intercalated in Glyme, MBE and LP71. The pristine graphite set as control.

FIG. 12 is a graph of first cycle coulombic efficiency of Li|Gr half cells with several electrolytes when charged at a charge rate of C/3.

FIG. 13 is a graph of the average coulombic efficiency from the last four cycles of Li|Gr half cells with several electrolytes when charged at a charge rate of C/3.

FIG. 14 is a graph of the average coulombic efficiency from the last four cycles of Li|Gr half cells with 1 m, 4 m, and 8 m concentrations of LiFSI in MBE.

FIG. 15 shows a graph of capacity after 30 cycles vs. total resistance of Li|Gr half cells with several electrolytes.

FIG. 16 shows the Rₒₕₘ, R_{SEI}, R_{ct}, and R_{SEI}+R_{ct} for Li|Gr half cells with several different electrolytes.

FIG. 17 shows a graph of R_{SEI} vs. percentage of anions in Li⁺ solvation shell in Li|Gr half cells with several different electrolytes.

FIG. 18 is a graph of capacity of LiGr cells when charged at different charge rates.

FIG. 19A-F show XPS results of the graphite electrode cycled Li|Gr half-cell using MBE electrolyte. (a) XPS survey; (b)-(f) high-resolution XPS spectra of F 1 s, O 1 s, N 1 s, C 1 s and S 2 p.

FIG. 20 is a graph of the first cycle coulombic efficiency of Li|LFP cells (1.88 mAh/cm², C/3).

FIG. 21 is a graph of the average coulombic efficiency of the last four cycles for the Li|LFP cells.

FIG. 22 is a graph of first cycle coulombic efficiency of Li|NMC cells (1.58 mAh/cm², C/3).

FIG. 23 is a graph of the average coulombic efficiency of the Li|NMC cells.

FIG. 24 is a graph of normalized capacity of Gr|LFP cells (N:P ratio: 1.06, 1.88 mAh/cm², xC charging, C/3 discharging) at various cycles at −20° C.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a solvent” includes reference to one or more of such materials and reference to “the layer” refers to one or more of such features.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of” For example, “at least one of A, B and C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein.

Accordingly, the scope of the invention should be determined solely by the appended claims and their legal equivalents, rather than by the descriptions and examples given herein.

### Example Embodiments

This disclosure describes lithium ion batteries and electrolytes that enable fast charging and low temperature operation of the batteries. The electrolytes can include a single-oxygen linear ether (SOLE) solvent and a lithium salt at least partially dissolved in the solvent. The lithium salt can include a sulfur-fluorine bond.

Lithium ion batteries (LIBs) have become a widespread form of energy storage technology due to their high energy density and stable cycling performance. However, current LIBs still fall short of applications at extreme temperatures, such as polar exploration, space missions. etc. Meanwhile, there is an increasing demand for faster charging rates of LIBs because long charging time represents a significant barrier for urban residents to adopt electric vehicles (EVs) and for long-distance road trips. To facilitate the development of fast-charging LIBs, the U.S. Department of Energy (DOE) set a target of charging to an 80% state of charge within 10 minutes for next-generation LIBs.

The development of fast-charging and low-temperature LIBs has been hindered by two challenges. First, when LIBs are operated at high charging rates or low temperatures, undesired side reactions such as lithium plating can happen. This not only reduces the amount of available lithium in LIBs, which leads to capacity fade, but also increases the tendency of internal short-circuit and the risk of thermal runaway. Second, LIBs suffer from large internal polarization (overpotential) when operated at high rates or low temperatures. Because LIBs are usually operated within a certain voltage window (typically 3.0-4.2V for LIBs with a layered oxide cathode), such large overpotential leads to early termination of the charge/discharge operation, thereby significantly reducing the usable capacity and energy. The overpotential is brought by the mass transfer and kinetic loss inside LIBs, which can be classified as ohmic overpotential, concentration overpotential and interfacial overpotential. Ohmic overpotential drives the migration of electrons in the electrodes and ions in the electrolyte, which is linearly proportional to ohmic resistance (Rₒₕₘ). Concentration overpotential is a non-linear function of the Li⁺ concentration in the liquid electrolyte, which becomes significant upon Li⁺ depletion (when Li⁺ diffusion in the electrode fails to replenish the consumed Li⁺ by the intercalation reaction). The interfacial overpotential is the driving force to relocate Li⁺ from the electrolyte bulk into the electrode material lattice. It contains the overpotential to drive Li⁺ to migrate through the solid electrolyte interphase (SEI) and the overpotential for the charge transfer reaction that involves Li⁺ de-solvation (major energy-consuming step), electron transfer and Li⁺ intercalation.

To enhance LIBs' usable capacity and energy under high rates and low temperature, the overpotential can be minimized. One approach is to reduce the ohmic and concentration overpotential by improving the bulk transport properties of the liquid electrolyte, i.e., the conductivity, Li⁺ diffusivity, and Li⁺ transference number. This can be achieved by using a low-viscosity solvent (such as methyl acetate) to partially or completely replace a viscous ethylene carbonate (EC) or using lithium salts with better dissociation ability than lithium hexafluorophosphate (LiPF₆), such as lithium bis(fluorosulfonyl)imide (LiFSI). Concentrated electrolytes can also enhance Li⁺ conduction and achieve a high Li⁺ transference number because their unique electrolyte structure, dominated by contact ion pairs (CIPs) and aggregates (AGGs), enables Li⁺ conduction via non-vehicle mechanisms, such as structural re-organization, hopping or cooperative ion transport.

Another approach to minimize overpotential is to minimize the interfacial overpotential by reducing SEI resistance (R_{SEI}) and the charge transfer resistance (R_{ct}). R_{SEI} depends on the thickness and composition of SEI, which is affected by electrolyte composition and can be prone to trace components (such as impurities, additives). In some cases, the SEI generated on graphite from an EC-based electrolyte can be thick. Such thick SEI is linked with the SEI growth mechanism in EC-based electrolyte. During the initial cycles, electrolyte decomposition generates a small amount of LiF and mainly lithium ethylene decarbonate (LEDC), which gradually decomposes into Li₂CO₃ during repeated cycling. Since Li₂CO₃ is not as electron-insulating as LiF, electrons can leak through Li₂CO₃, and then continuously reduce the electrolyte and make SEI grow. On the other hand, EC-based electrolyte usually has large R_{ct}. This is because EC, as a very polar solvent (dielectric constant 89.8), strongly binds with Li⁺, which leads to a large de-solvation energy of 50-70 kJ/mol and a large Re.

In some examples, electrolytes with low interfacial resistance (R_{SEI}+R_{ct}) can satisfy the below guidelines. First, the electrolyte can be compatible with graphite, the state-of-the-art anode materials for LIBs. This means the electrolyte can have very low to no solvent co-intercalation and be able to form a stable SEI on the graphite anode. Second, the electrolyte can have low de-solvation energy, which means the electrolyte can have a weak binding between the solvent and Li⁺. This can be achieved by using solvents with low polarity and basicity. Another approach is to introduce steric hindrance to the donor atom of the solvent. For example, by replacing the two-ending methyl group in glyme with two ethyl groups, the de-solvation energy can be reduced by 10 kJ/mol. By reducing the basicity of the donor atom via substituting H with F, the binding energy can also be reduced. Thirdly, the electrolyte can promote the formation of a thin SEI with high Li⁺ conductivity. After formation, SEI can grow by the reduction of electrolyte via leaked electrons, or anion/solvent reduction as they diffuse through the formed SET. Therefore, SEI can be dense to minimize solvent/anion diffusion and electron-insulating to minimize electron leakage. In some examples, a LiF-rich SEI can be thin and compact. A LiF-rich SEI can be realized by using fluorinated solvents or additives, such as FEC, or salt, such as lithium bis(trifluoromethanesulfonyl)imide (LiTFSI), lithium (fluorosulfonyl)(trifluoromethanesulfonyl)imide (LiFTFSI) and LiFSI.

Compared with the organic carbonate solvents used in LIB electrolytes, ethers exhibit stronger resistance to reduction. As a result, the SEI formed in ether-based electrolytes tends to be thinner and is composed primarily of inorganic Li compounds rather than organic compounds, because anion decomposition dominates the SEI formation. For this reason, ether-based electrolytes have been used in Li metal batteries. However, ether has a high tendency to co-intercalate into graphite with Li⁺. This can cause undesired co-intercalation in LIBs having a graphite anode. In some cases, using a high salt concentration in the electrolyte can help avoid the co-intercalation of ether, but the high cost and high viscosity of such electrolytes hinder their practical application.

The electrolytes described herein can be used in lithium ion batteries with graphite electrodes to provide fast charging speed and good low-temperature performance. The electrolytes include an ether solvent, but do not cause an undue amount of undesired co-intercalation with the graphite anode. In particular, the combination of a single-oxygen linear ether solvent and a lithium salt that includes a sulfur-fluorine bond is used to achieve these results. The SOLE solvent can have a high resistance to reduction, as explained above. The sulfur-fluorine bond in the lithium salt can be easily broken to release fluorine. The fluorine can combine with lithium to form LiF. The LiF forms a surface layer on the graphite anode. Thus, the solid electrolyte interphase is rich in LiF. The LiF SEI can be thin and compact, and it has been found to prevent intercalation of the SOLE solvent into the graphite anode. The lithium salt having a sulfur-fluorine bond has surprisingly been found to form this LiF-rich SEI better than other types of fluorine-containing salts, such as salts that include P—F, As—F, B—F, Sb—F, or C—F bonds. The sulfur-fluorine bond has an average bond energy of 284 kJ/mol, whereas the carbon-fluorine bond can be up to 543 kJ/mol, making the sulfur-fluorine bond easier to break.

The SEI can also include other components besides the LiF, such as compounds formed by the decomposition of solvent molecules. However, the SEI in the lithium batteries described herein can have a higher content of LiF than batteries made with many other types of electrolytes. The content of LiF can be related to the concentration of F in the SEI layer, which has been measured at around 28% to 29% in some example batteries constructed according to the present technology. In some examples, the SEI layer can have a F concentration of 20 wt % to 40 wt %, or 25 wt % to 35 wt %, or 26 wt % to 32 wt %, or 27 wt % to 30 wt %, or 28 wt % to 29 wt %. The lithium batteries according to the present invention can also have a SEI layer with a F/O ratio that is greater than in many other lithium batteries. In some example batteries constructed according to the present technology, the SEI layer had a F/O ratio measured at 0.84 to 1.43. An example lithium battery that had ethylene carbonate as the electrolyte solvent, for comparison, was measured to have a F/O ratio of 0.23. In some examples, the batteries according to the present technology can have an SEI layer with a F/O ratio from 0.7 to 1.6, or from 0.8 to 1.5, or from 0.9 to 1.3, or from 1.0 to 1.2.

In some examples, the lithium salt used in the electrolyte can be lithium bis(fluorosulfonyl)imide (LiFSI). LiFSI has a lower ionic bond strength than many other common lithium salts, such as LiOTF, LiBF₄, LiClO₄, and LiTFSI. This makes LiFSI more soluble in organic solvents, including the SOLE solvents used in the present technology. LiFSI also has better chemical and thermal stability than some other lithium salts, such as LiPF₆.

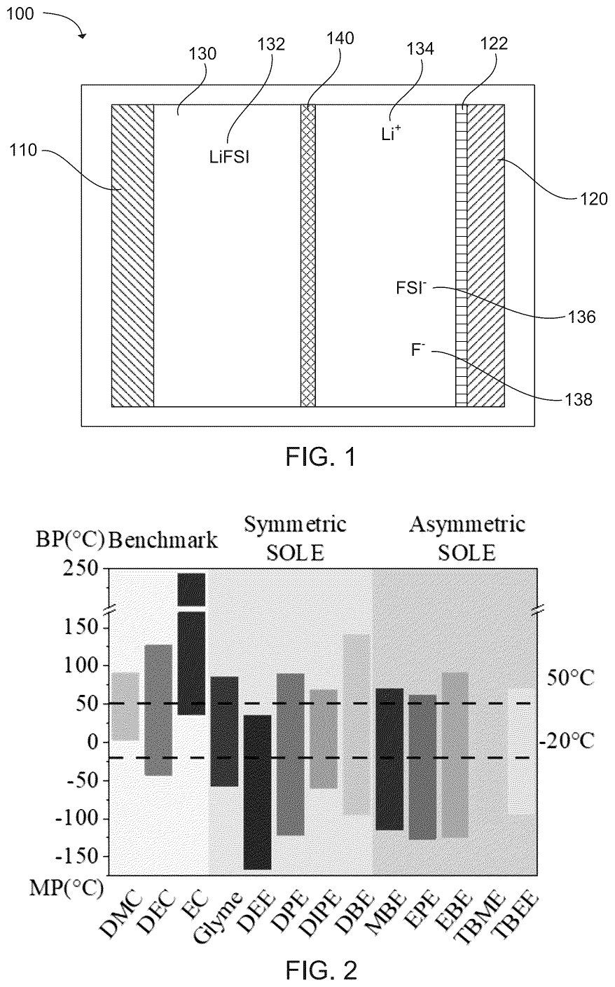

FIG. 1 shows a schematic view of an example lithium ion battery 100 in accordance with the present technology. This example includes a cathode 110, an anode 120, a liquid electrolyte 130 in contact with both the cathode and the anode, and a separator 140 between the cathode and the anode. The liquid electrolyte can include a SOLE solvent and a lithium salt 132 at least partially dissolved in the solvent. The lithium salt can include a sulfur-fluorine bond. In this example, the lithium salt is LiFSI. This salt can dissolve in the SOLE solvent and dissociate into Li⁺ cations 134 and bis(fluorosulfonyl)imide (FSI⁻) anions 136. Additionally, the anions can decompose to release fluoride (F⁻) anions 138. These fluoride ions can react with Li⁺ ions to form a LiF-rich SIE layer 122 on the surface of the anode.

The cathode used in the lithium ion battery can include any cathode materials suitable for use in lithium ion batteries. In some examples, the cathode can include a multi-metal oxide that includes lithium and at least one other metal. Non-limiting specific examples of cathode materials can include lithium iron phosphate (LFP), lithium nickel manganese cobalt oxide (NMC), lithium cobalt oxide (LiCoO₂), lithium manganese oxide (LiMn₂O₄), lithium nickel cobalt aluminum oxide (NCA), and combinations thereof. In a particular example, the cathode material can include LiFePO₄.

The anode used in the lithium ion battery can be capable of allowing reversible intercalation of lithium ions into the anode. In many examples, the anode can include graphite. Lithium ions can reversibly intercalate between graphite layers in the graphite anode. As explained above, ether solvents can often co-intercalate with lithium ions into graphite anodes. This co-intercalation can cause undesired effects such as exfoliation of the graphite anode. However, as mentioned above, the liquid electrolytes described herein can help prevent this co-intercalation by including a lithium salt having a sulfur-fluorine bond together with a single-oxygen linear ether solvent. As used herein, “reversible” refers to being substantially reversible, such as 99.9% reversible, for example. In practice, the anode can reversibly intercalate lithium ions with efficiency of 99.90% to 99.98% in some examples.

The anode can include a solid electrolyte interphase (SEI) that comprises lithium fluoride (LiF). In some examples, the SEI can form when the lithium ion battery goes through charge/discharge cycles. For example, the lithium ion battery can be manufactured with a graphite anode that initially does not include a SEI containing LiF. However, after charge cycling the battery one or more times, the SEI can form on the anode. In certain examples, the SEI can form after 1 cycle, or after 2 cycles, or after 3 cycles, or after 5 cycles, or after a number of cycles from 1 to 10, or 1 to 20.

The thickness of the LiF SEI can be less than the thickness of SEI layers formed when organic carbonate solvents are use. When an organic carbonate solvent is used, the solvent can often break down to form Li₂CO₃, which can make up some or all of the SEI layer. The Li₂CO₃ can be bulky and less compact than LiF. Li₂CO₃ is not as electron-insulating as LiF. Therefore, electrons can continuously leak through the Li₂CO₃ layer to continuously reduce more of the solvent, causing the SEI to grow thicker. In some cases, the LiF SEI in the batteries described herein can have a thickness from about 2.5 nm to about 10 nm. This can be much more compact than SEI layers formed of Li₂CO₃, which can often be around 50 nm thick.

A separator can be placed in the lithium ion battery between the cathode and the anode. In some examples, the separator can be a porous membrane. The membrane can be capable of allowing lithium ions to transfer across the membrane. In some examples, the separator can be a membrane made from polymers such as polyethylene, polypropylene, or a combination thereof. In further examples, the separator can be a nonwoven separator, a ceramic composite separator, or a combination of these separators.

Regarding the single-oxygen linear ether (SOLE) solvents, these are ether solvents with two alkyl groups attached to the O atom on both sides. SOLEs can be symmetric or asymmetric, depending on whether the two alkyl groups are the same. Depending on the chain length, SOLEs can be gas, liquid or solid at room temperature at one atmospheric pressure. The SOLEs used in the present technology can be liquids at 30° C., making them appropriate for use in liquid electrolytes for lithium ion batteries. This excludes short chain SOLEs such as dimethyl ether (DME, boiling point: −24° C.) and methyl ethyl ether (MEE, boiling point: 7.4° C.). In addition, symmetric SOLEs with chain lengths longer than dibutyl ether (DBE) have a high viscosity. Therefore, these SOLEs may not be suitable for use as a liquid electrolyte. Asymmetric SOLEs with chain lengths longer than ethyl butyl ether (EBE) can be used, but may be difficult to find commercially available. Therefore, in some examples the SOLEs used in the liquid electrolytes described herein can include diethyl ether (DEE), dipropyl ether (DPE), di-isopropyl ether (DIPE), dibutyl ether (DBE), methyl butyl ether (MBE), ethyl propyl ether (EPE), ethyl butyl ether (EBE), tert-butyl methyl ether (TBME), tert-butyl ethyl ether (TBEE), or combinations thereof.

Table 1 summarize the physical properties and chemical structure of several SOLEs. The SOLEs are also compared to Glyme and LP71, which is a 1:1:1 (wt %) mixture of ethylene carbonate (EC), dimethyl carbonate (DMC), and diethyl carbonate (DEC).

TABLE 1
Structure and Viscosity of SOLE Solvents

| | | | | | | Dielectric | |
|---|---|---|---|---|---|---|---|
| Category | Compound | Abb. | Structure | (Cp) | Ref. | constant | Dipole |
| Control | 1m LiPF₆ in | LP71 | | | | | |
| | 1/1/1 wt/wt/wt | | | | | | |
| | EC/DMC/DEC | | | | | | |
| | Dimethoxyethane | Glyme | 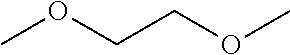 | 0.41 at 25° C. | 1 | 7.3 | 1.7 |
| Symmetric SOLE | Diethyl ether | DEE | 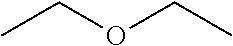 | 0.235 at 20° C. | 2 | 4.33 | 1.3 |
| | Dipropyl ether | DPE | 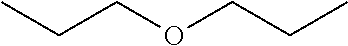 | | | 3.39 | 1.12 |
| | Diisopropyl ether | DIPE | 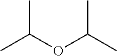 | 0.33 at 20° C. | 3 | 3.8 | 1.3 |
| | Dibutyl ether | DBE | 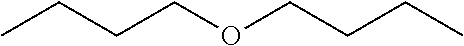 | 0.69 at 20° C. | 3 | 3.1 | 1.18 |
| Asymmetric SOLE | Methyl Butyl ether | MBE | 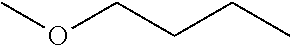 | | | 4.2 | 1.27 |
| | Ethyl Propyl ether | EPE | 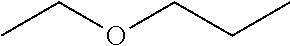 | | | | 1.16 |
| | Ethyl Butyl ether | EBE | 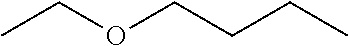 | | | | 1.24 |
| | tert-Butyl Methyl ether | TBME | 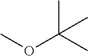 | 0.65 at 25° C. | 4 | 4.5 | 1.32 |
| | tert-Butyl Ethyl ether | TBEE | 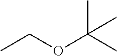 | 0.40 at 25° C. | 5 | | |

The melting points (MP) and boiling points (BP) of the SOLEs are summarized in FIG. 2 with the typical operating temperature range of LIBs represented by the black dash lines. All SOLEs except DEE are liquid within this temperature range. Generally, both MPs and BPs of SOLEs increase with chain length, likely due to the increasing molecular weight. The chemical structure also plays a role, as demonstrated by DPE and DIPE, which have the same molecular weight but quite different BPs and MPs. It is noteworthy that all these solvents remain as a liquid even under −20° C., while typical commercial carbonate electrolyte containing EC freezes at this temperature (e.g., the eutectic mixture of EC:DMC freezes at −7.6° C.).

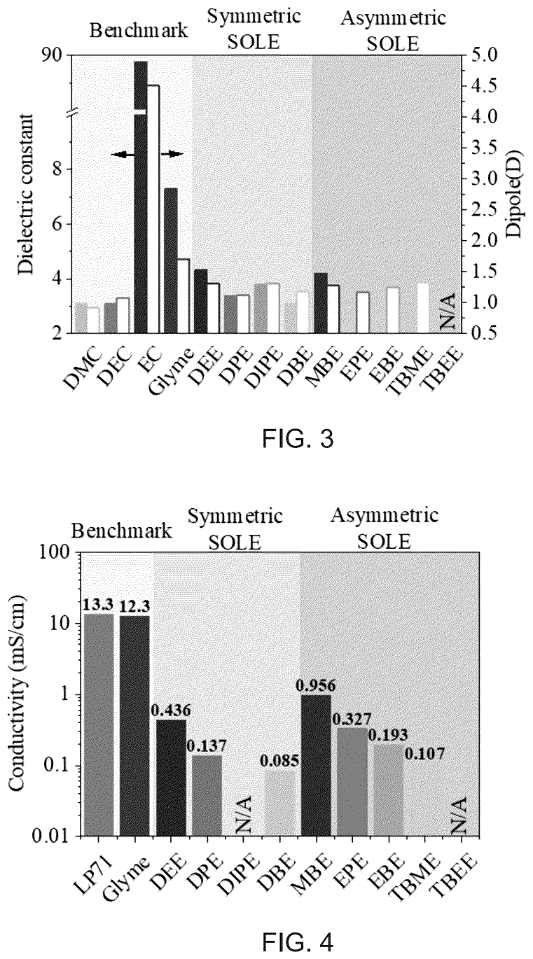

As shown in FIG. 3, with dielectric constants in the range of 3-5, SOLEs are less polar than Glyme and far less polar than EC (dielectric constant=89.8). Moreover, symmetric SOLEs generally show lower polarity compared to asymmetric SOLEs. Despite the low viscosity of SOLEs (in the range of 0.2-0.7 cp), 1 m LiFSI-SOLE electrolytes show much lower conductivity than LP71 and 1 m LiFSI-glyme (FIG. 4), which is attributed to their low polarity and thus poor salt dissociation. For asymmetric SOLEs, 1 m LiFSI-MBE shows the maximum conductivity (0.97 mS/cm), and the conductivity decreases as chain length increases due to the combined effect of decreasing polarity and increasing viscosity. For symmetric SOLEs, a similar trend is observed. These results suggest the presence of a large amount of undissociated Li⁺-anion pair in the SOLE electrolytes, which is also confirmed by the Raman spectroscopy study as discussed below.

In certain examples, the SOLE solvent used in the electrolytes described herein can be an asymmetric SOLE. As explained above, the asymmetric SOLEs can have higher polarity than the symmetric SOLEs. Additionally, in some examples the SOLE can have a number of carbon atoms from 4 to 8. The molecules having from 4 to 8 carbon atoms can have a conductivity and viscosity that works well in the lithium ion batteries described herein. In some particular examples, the SOLE can be selected from the group consisting of: methyl butyl ether (MBE), ethyl propyl ether (EPE), ethyl butyl ether (EBE), tert-butyl methyl ether (TBME), tert-butyl ethyl ether (TBEE), and combinations thereof.

A lithium salt can be at least partially dissolved in the SOLE solvent. The lithium salt can include lithium as a cation with an anion that includes a sulfur-fluorine bond. Some examples of lithium salts include lithium bis(fluorosulfonyl)imide, lithium (fluorosulfonyl) (trifluoromethanesulfonyl)imide, lithium (fluorosulfonyl) (pentafluoroethanesulfonyl)imide, and lithium trifluoromethanesulfonate. In certain examples, the lithium salt can include lithium bis(fluorosulfonyl)imide (LiFSI). LiFSI has a low ionic bond strength compared to other common Li salts, such as LiOTF, LiBF₄, LiClO₄, and LiTFSI. Therefore, LiFSI has the highest solubility of these options. Other common Li salt solubilities are given in Table 2.

TABLE 2
Solubility of Each Salt in MBE

| Salt | Solubility (mol/kg) |
|---|---|
| LiFSI | 8.3 |
| LiTFSI | 6.8 |
| LiPF₆ | 3.7 |

The solubility of LiFSI ensures a sufficient Li⁺ concentration in the weakly polar SOLEs. LiFSI also has better chemical and thermal stability than LiPF₆. Additionally, the S—F bond in FSI⁻ is prone to break, which generates a Li—F rich SEI.

In some examples, the lithium salt can be present in the liquid electrolyte at a concentration from about 0.5 mol/kg to about 3 mol/kg with respect to the total weight of the liquid electrolyte. In further examples, the concentration can be from about 0.5 mol/kg to about 2.5 mol/kg, or from about 0.5 mol/kg to about 2.0 mol/kg, or from about 0.5 mol/kg to about 1.5 mol/kg, or from about 0.5 mol/kg to about 1.0 mol/kg, or from about 1.0 mol/kg to about 2.5 mol/kg, or from about 1.0 mol/kg to about 2.0 mol/kg, or from about 1.0 mol/kg to about 1.5 mol/kg, or from about 1.5 mol/kg to about 2.5 mol/kg, or from about 1.5 mol/kg to about 2.0 mol/kg, or from about 2.0 mol/kg to about 2.5 mol/kg.

The SOLE solvents can have a relatively weak solvating power. Consequently, when the lithium salt is dissolved in the SOLE solvent, the resulting solvation structure can be dominated by contact ion pairs (CIPs) and aggregates (AGGs). CIPs refers to pairs of a lithium ion and a single anion that are paired in contact one with another. A number of solvent molecules can also be in contact with the lithium ion. Thus, the solvation shell of the lithium ion can include a single anion and a number of solvent molecules. AGGs refers to a lithium ion that has multiple anions in its solvation shell. As used here, “AGG-I” can refer to an aggregate that includes a lithium ion with two anions in its solvation shell, and “AGG-II” can refer to an aggregate that includes a lithium ion with three anions in its solvation shell. A number of solvent molecules can also be in the solvation shell of the lithium ion. In contrast to CIPs and AGGs, free anions can refer to anions that are not in contact with a lithium ion. Instead, a free anion is completely surrounded by solvent molecules. In some examples, the liquid electrolytes described herein can be substantially free of free anions, meaning that there are substantially no anions completely surrounded by solvent molecules. In other words, in this example, all anions present in the liquid electrolyte can be part of a solvation shell of a lithium ion. The anions can be in CIPs or AGGs. In certain examples, the liquid electrolyte can be substantially free of free anions and substantially free of CIPs. In such examples, all of the anions can be present in AGGs. In further examples, from about 0% to about 30% of the anions in the liquid electrolyte can be in the form of CIPs, and from about 70% to about 100% of the anions can be in the form of AGGs. In still further examples, from about 50% to about 100% of the anions can be in the form of AGG-I, having two anions in contact with a lithium ion, and from about 0% to about 50% of the anions can be in the form of AGG-II, having three anions in contact with a lithium ion. In certain examples, the lithium salt can be LiFSI, and the liquid electrolyte can substantially free of free FSI⁻ anions.

With the details of the lithium ion batteries and liquid electrolytes in mind, the present technology also includes methods of using lithium ion batteries. In one example, a method of using a lithium ion battery can include charging or discharging the lithium ion battery. The lithium battery can include a cathode, an anode, and a liquid electrolyte in contact with the cathode and the anode. The anode can allow reversible intercalation of lithium ions into the anode. The liquid electrolyte can include a single-oxygen linear ether solvent and a lithium salt at least partially dissolved in the solvent. The lithium salt can include a sulfur-fluorine bond. The lithium ion battery can also include any of the features and components described above.

As explained above, the anode of the lithium ion battery can include a solid electrolyte interphase (SEI) layer that includes LiF. The LiF is formed from lithium ions that are present in the electrolyte because of dissolution of the lithium salt and fluoride ions that are present because of the breaking of the sulfur-fluorine bond in the lithium salt. The anion of the salt can decompose to release the fluoride ion. In some examples, the SEI may not be present initially when the lithium battery is constructed. Charging and discharging the lithium ion battery can cause the SEI to form. Therefore, in some examples, the method of using the lithium ion battery can include forming the SEI. The forming of the SEI can be accomplished by charging and discharging the battery multiple times. In some examples, the SEI can be formed by charging and discharging the lithium ion battery 1 time, 2 times, 3 times, 5 times, 1 to 10 times, or 1 to 20 times.

The lithium ion batteries can also be capable of operating at lower temperatures than many other lithium ion batteries. Therefore, the methods of using the lithium ion batteries can include charging or discharging the battery at a low temperature. In some examples, the low temperature can be from −25° C. to −10° C. In other examples, the lithium ion battery can be charged and discharged at temperatures of −25° C. or greater, or −20° C. or greater, or −10° C. or greater, or 0° C. or greater.

The methods of using the lithium ion batteries can also include charging or discharging at high rates. In some examples, the lithium ion battery can be charged at a charge rate from about 4 C to about 8 C. In further examples, the charge rate can be from about 4 C to about 7 C, or from about 4 C to about 6 C, or from about 4 C to about 5 C, or from about 5 C to about 8 C, or from about 5 C to about 7 C, or from about 5 C to about 6 C, or from about 6 C to about 8 C, or from about 6 C to about 7 C, or from about 7 C to about 8 C. As used herein, the charge rate, or C-rate, refers to a rate of charging the battery from 0% capacity to 100% capacity, where a rate of 1 C charges the battery from 0% to 100% capacity in 1 hour. A rate of 4 C is four times faster than 1 C, and therefore the battery would be charged from 0% to 100% in one fourth of one hour. Similarly, at a rate of 8 C, the battery would be charged from 0% to 100% in one eighth of one hour.

In some cases, charging the battery more slowly can allow the battery to charged more fully. Therefore, slower charge rates of less than 1 C can also be used. However, using a lower charge rate results in longer charge times. In certain examples, the lithium ion batteries described herein can have charge times of 8 minutes or even lower. The same batteries can also be charged more slowly using a longer charge time. In various examples, the lithium ion battery can be charged to full capacity over a charging time from about 8 minutes to about 5 hours, or from about 8 minutes to about 3 hours, or from about 8 minutes to about 2 hours, or from about 8 minutes to about 1 hour, or from about 8 minutes to about 30 minutes, or from about 8 minutes to about 15 minutes, or from about 15 minutes to about 5 hours, or from about 15 minutes to about 3 hours, or from about 15 minutes to about 2 hours, or from about 15 minutes to about 1 hour, or from about 15 minutes to about 30 minutes, from about 30 minutes to about 5 hours, or from about 30 minutes to about 3 hours, or from about 30 minutes to about 2 hours, or from about 30 minutes to about 1 hour, or from about 1 hour to about 5 hours, or from about 1 hour to about 3 hours, or from about 1 hour to about 2 hours, or from about 2 hours to about 5 hours, or from about 2 hours to about 3 hours, or from about 3 hours to about 5 hours.

Manufacturing the lithium ion batteries described herein can be done using any suitable manufacturing method for lithium ion batteries. In some examples, the liquid electrolytes described herein can be seamlessly integrated into the current battery production line. For example, the liquid electrolyte can replace electrolytes previously used in lithium batteries with graphite anodes. Using the liquid electrolyte described herein can allow the batteries to have faster charging speeds and better low-temperature performance. The SOLE-based electrolytes described herein can have high compatibility with graphite anodes at normal salt concentrations (i.e., around 1 mol/kg) and better fast charging and low-temperature performance many other electrolytes. Such superior fast charging and low-temperature performance may be attributed to the lowered interfacial resistance. Graphite (Gr)|LiFePO₄ (LFP) full cells with the example SOLE based electrolyte have shown a capacity retention of 77.3% after 1,000 cycles. Raman spectroscopy results have shown that due to the low polarity of the SOLE solvents, the structure of these electrolytes contains a significant amount of contact ion pairs (CIPs) and aggregates (AGGs) similar to high concentration electrolyte (HCE) and localized high concentration electrolyte (LHCE). X-ray photoelectron spectroscopy results have shown that these electrolytes form LiF-rich solid electrolyte interphase (SEI). These features can contribute to the providing lithium ion batteries for extremely fast charging and low-temperature performance without sacrificing cycling stability. Experimental tests of the lithium ion batteries and liquid electrolytes described above are detailed in the examples below.

### Examples

A series of ether-based electrolytes were prepared for study. The electrolytes include LiFSI as the lithium salt dissolved in several different SOLE solvents. The solvents used were (DEE), dipropyl ether (DPE), dibutyl ether (DBE), methyl butyl ether (MBE), ethyl propyl ether (EPE), ethyl butyl ether (EBE), and tert-butyl methyl ether (TBME). The molality of each electrolyte was 1 mol/kg. Table 3 shows the density and molarity of each of these example electrolytes.

TABLE 3
Concentration Transfer of Each SOLE Electrolyte

| Electrolyte | DEE | DPE | DBE | MBE | EPE | EBE | TBME |
|---|---|---|---|---|---|---|---|
| Density(g/cm3) | 0.713 | 0.736 | 0.768 | 0.744 | 0.739 | 0.750 | 0.740 |
| Molality(mol/kg) | 1 | 1 | 1 | 1 | 1 | 1 | 1 |
| Molarity(mol/L) | 0.71 | 0.69 | 0.70 | 0.74 | 0.72 | 0.69 | 0.70 |

These electrolytes can boost a lithium ion battery's fast charging and low-temperature performance without compromising its cycling stability. This may be due to unique features of the ether solvents, which are weakly polar (dielectric constant of 3-4.5) and capable of forming anion dominated Li⁺ solvation shells that are prone to de-solvate and exhibit anion decomposition. Electrochemical results of Li|graphite (Gr), Li|LiFePO₄ (LFP), Li|NMC half-cells and Gr|LFP full cells are presented to examine the compatibility of these electrolytes with Gr anode, LFP cathode and NMC cathodes. Voltammetry and spectroscopic results are discussed to elucidate the electrolyte structure, SEI formation, de-solvation, and their correlation with interfacial resistances.

### Properties of SOLEs and SOLE Electrolytes.

LiFSI was compared with other salts and it was found that LiFSI shows a better cycling performance and higher coulombic efficiency (CE). Hence, 1 m LiFSI-SOLE electrolytes are used in the following experiments unless otherwise specified. 1 m LiFSI-glyme is used as a benchmark ether electrolyte, 1 M LiPF₆ in 1:1:1 (wt %) EC/DMC/DEC (LP71) is used as the benchmark carbonate electrolyte because this carbonate electrolyte is designed for low-temperature operation with a melting point below −30° C. The properties and performance of the SOLE electrolytes are compared with the benchmarks wherever possible in the following discussion.

To examine the volatility of SOLE electrolytes, LiFSI-MBE electrolyte, as a representative system, was examined by thermogravimetric analysis (TGA) and compared with 1 M LiPF₆ in 1:1:1 (wt %) EC/DMC/DEC (LP71). The results showed that LiFSI-MBE electrolyte exhibits comparable or lower volatility than LP71 under 150° C.

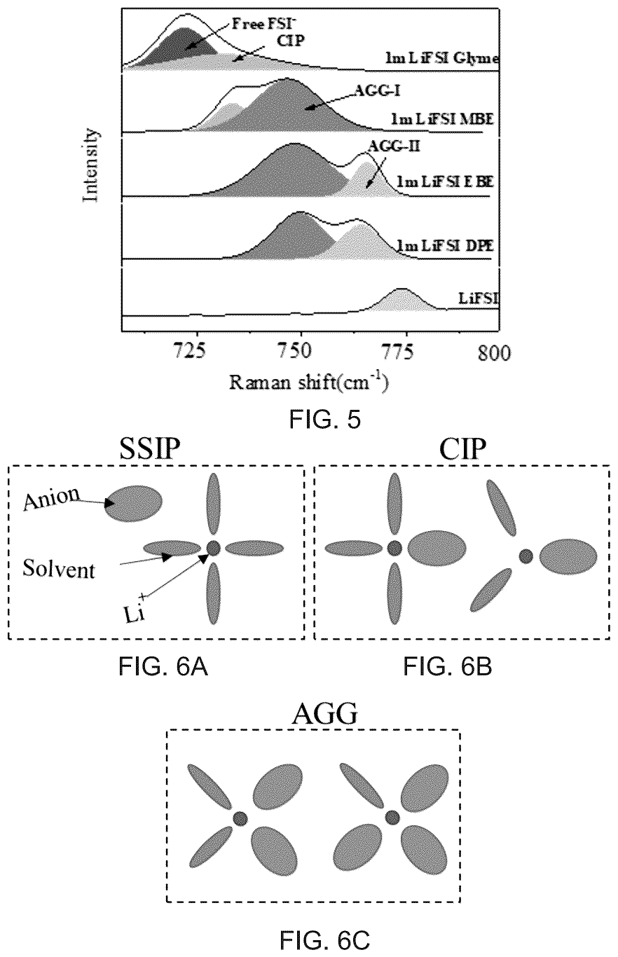

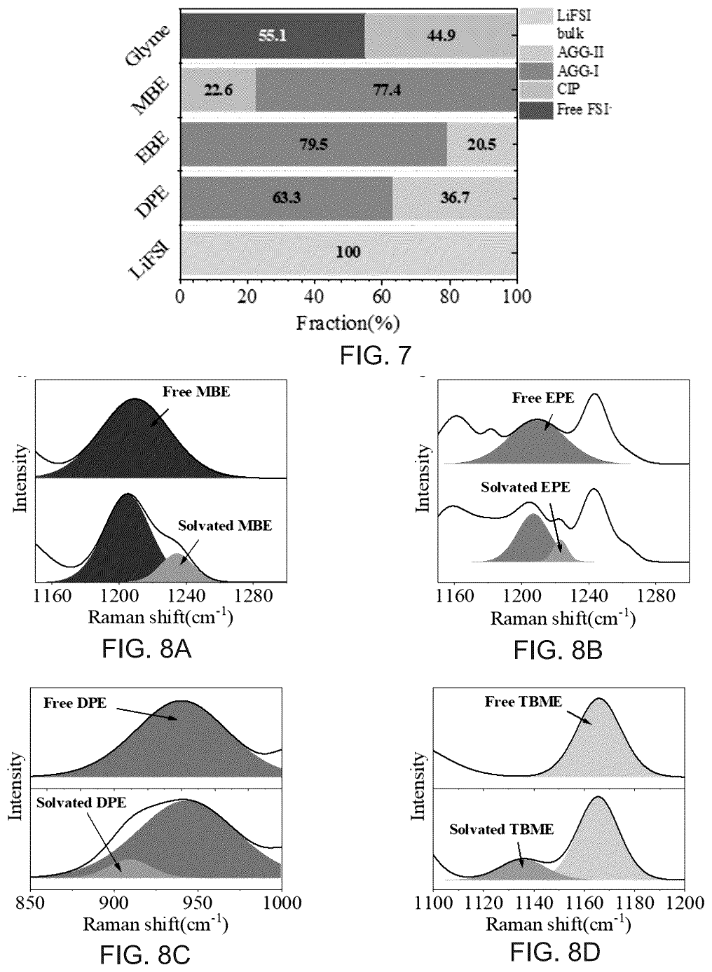

To reveal the solvation structure of Li⁺ in SOLE electrolytes, the Raman spectroscopy of several representative SOLE electrolytes (1 m LiFSI in MBE, EBE and DPE) are compared with that of 1 m LiFSI-Glyme. As shown in FIG. 5, pure LiFSI salt shows an S—N—S bending signal at 774 cm⁻¹. After dissolving into Glyme, the S—N—S bending signal shifts to 717 cm⁻¹. However, a much smaller shift is observed when LiFSI dissolves into the less polar SOLE solvents, suggesting stronger coordination of Li⁺ with FSI⁻ in the LiFSI-SOLE electrolyte. The Raman spectroscopy results are fitted based on the previously reported method, in which the peaks are deconvolved into free FSI⁻, contact ion pair (CIP), aggregate (AGG), corresponding to FSI⁻ in different coordination environments (FIG. 6A-6C, respectively). The assignment of peaks is based on literature and summarized in Table 4. 1 m LiFSI-glyme shows a high fraction of fully dissociated LiFSI (55.1%) due to the relatively high polarity of Glyme. However, in 1 m LiFSI-MBE, a high fraction of CIPs and aggregates (AGGs) are observed but no free FSI⁻. Dissolving LiFSI into the even less polar EBE and DPE electrolyte shows a less shift of the S—N—S bending signal and more AGGs. FIG. 7 shows the percentages of AGG-1, AGG-2, CIP, and free FSI⁻ in the electrolytes. These results demonstrate that SOLE electrolytes can form an anion-dominated Li⁺ solvation shell, which is prone to generate anion-derived SEI on graphite instead of solvent-derived SEI. As demonstrated, such anion-derived SEI can effectively prevent solvent co-intercalation in graphite anodes.

TABLE 4
Raman Band Positions for Different Types of Solvate Structures

| | Raman shift (cm⁻¹) (This work and reference) | | | | |
|---|---|---|---|---|---|
| Structure | Glyme | MBE | EBE | DPE | Position in Literatures |
| Free FSI⁻ | 718.3 | | | | 718-720 |
| CIP | 728.5 | 732.8 | | | 728-734 |
| AGG-I | | 747.8 | 751.1 | 748.2 | 738-751 |
| AGG-II | | | 763.4 | 762.7 | 750-763 |

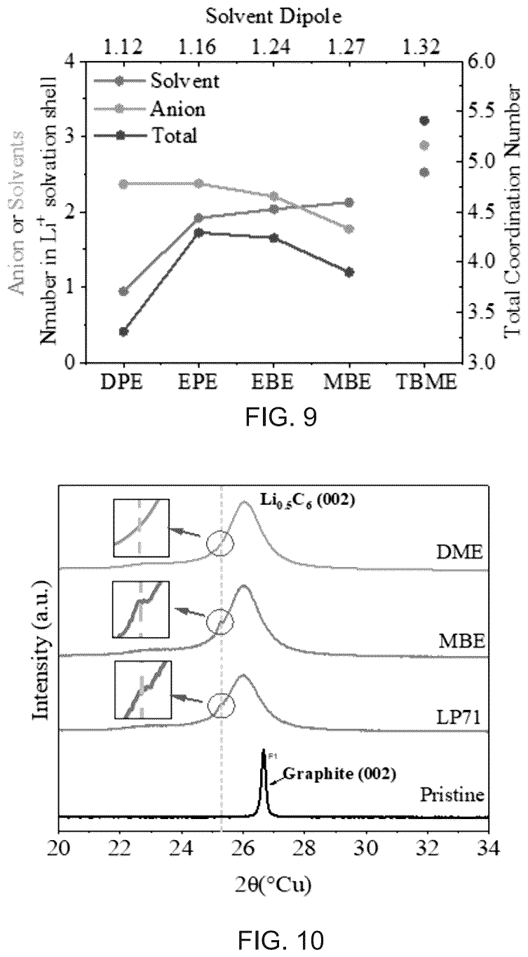

The C—O—C signal of the ether solvent splits into two separate peaks after LiFSI salt dissolves into the solvent, suggesting that the solvents also participate in the solvation of Li⁺. The two peaks correspond respectively to the solvated solvent and free solvent. FIG. 8A-8D shows the Raman spectra of 1 m LiFSI in (A) MBE; (B) EPE; (C) DPE; and (D) TBME. By comparing their peak area, the solvent coordination number in the Li⁺ solvation shell is calculated and given in FIG. 9. In these SOLE electrolytes, the total coordination number (including solvent and anion) of Li⁺ is 3-5. As the solvent dipole moment increases, more solvent molecules enter the solvation shell, and simultaneously FSI⁻ anions leave the solvation shell. For instance, due to its symmetric structure, DPE shows a very low polarity, which results in 0.94 solvent molecules and 2.4 FSI⁻ in the solvation shell. For MBE with a larger dipole of 1.27, 2.1 solvent molecules are in the solvation shell, and FSI⁻ coordination number decreases to 1.7. TBME does not follow this overall trend, possibly because of the steric effect of the tert-butyl function group. These results suggest a new direction to modify the Li⁺ solvation structure. By altering the solvent polarity without changing electrolyte composition and solvent functional group, the solvation structure of Li⁺ can be tailored.

Compatibility of SOLE Electrolyte with Graphite Anode.

To evaluate the compatibility of SOLE electrolytes with graphite anodes, Li|Gr cells were constructed and tested using 1 m LiFSI-SOLE as electrolytes. Unless otherwise specified, all cells were cycled at C/3 rate. When mixing 1 m LiFSI with SOLEs, homogenous solutions are observed for all SOLEs except DIPE and TBEE. Thus, DIPE and TBEE were not tested in the subsequent experiments. The phase separation of DIPE and TBEE may be attributed to thermodynamic reasons.

During the first lithiation, LP71 exhibits a very short plateau at ˜0.7 V, corresponding to electrolyte decomposition and the formation of SEI on the graphite anode. In contrast, the glyme-based system shows clear co-intercalation, as suggested by a significant reduction capacity above 0.4 V. In the case of SOLE electrolytes, no co-intercalation was observed in SOLE electrolytes. Instead, the reduction of FSI⁻ occurs at ˜1.0 V.

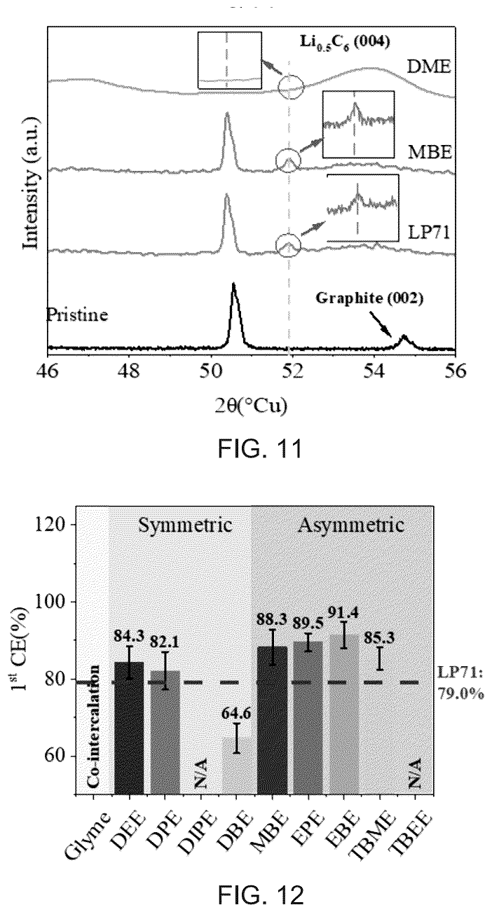

In order to investigate the effectiveness of the SEI in preventing solvent co-intercalation, X-ray Diffraction (XRD) analysis was conducted on graphite electrodes that were cycled in LP71, MBE, and Glyme electrolytes. The XRD results are presented in FIG. 10 (002 peaks) and FIG. 11 (004 peaks). In the XRD patterns, the pristine graphite electrode exhibits characteristic peaks at 2θ=26.5° (002 peak) and 54.6° (004 peak), indicating a graphite interlayer distance of 3.36 Å. This corresponds to the ordered arrangement of carbon layers in pristine graphite. Upon lithium-ion intercalation, the 002 and 004 peaks of graphite cycled in LP71 and MBE shift to 2θ=25.3° and 51.9°, respectively, suggesting a larger interlayer distance of 3.52 Å, which is consistent with previous literature reports. The results confirm that SEI generated by SOLE electrolytes successfully prevents solvent co-intercalation in graphite anode. On the contrary, the graphite cycled in Glyme, which has the same salt as the SOLE electrolyte, does not show the Li_{0.5}C₆ peak, which represents solvent co-intercalation as reported by other report.

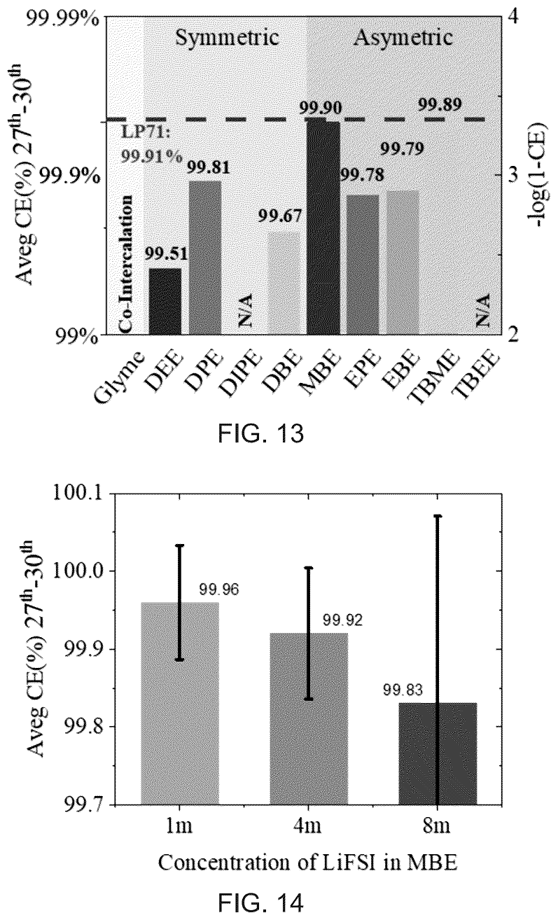

The first cycle coulombic efficiencies (1^{st} CE) are compared in FIG. 12. Notably, SOLE electrolytes, except for 1 m LiFSI-DBE, show a higher 1^{st} CE than LP71. 1 m LiFSI-EBE electrolyte even reaches a 1^{st} CE of 91.4%. For electrolytes, CE gradually increases with the cycle and stabilizes at ˜30^{th} cycle, indicating the gradual formation of stable SEI. The average CEs (the last 4 cycles) are calculated and compared, as shown in FIG. 13. SOLE electrolytes show a high CE of >99.50% after 30 cycles, and 1 m LiFSI-MBE can even reach a CE of 99.90%, which is very close to the CE of LP71 (99.91%). These results indicate that SOLE electrolytes can not only avoid solvent co-intercalation, commonly observed in ether-based electrolytes, but also form a stable SEI on graphite at normal concentration. To investigate the effect of concentration, LiFSI-MBE electrolyte of different concentrations were tested. The conductivity is given in Table 5.

TABLE 5
Conductivity of Different Concentrations of LiFSI in MBE

| Concentration(mol/kg) | Conductivity(ms/cm) |
|---|---|
| 1 | 0.96 |
| 2 | 1.2 |
| 4 | 1.4 |
| 6 | 1.2 |
| 8 | 0.74 |

Maximum conductivity for this system occurs at 4 m, which is different from the commercial carbonate electrolyte. The average CE of 1 m, 4 m and 8 m LiFSI in MBE in Li|Gr cells are compared in FIG. 14, and 1 m LiFSI-MBE has slightly better CE than the others. These results illustrated SOLE electrolytes have good compatibility with graphite at normal salt concentration (1 mol/kg) and concentrated SOLE electrolyte does not further enhance the CE.

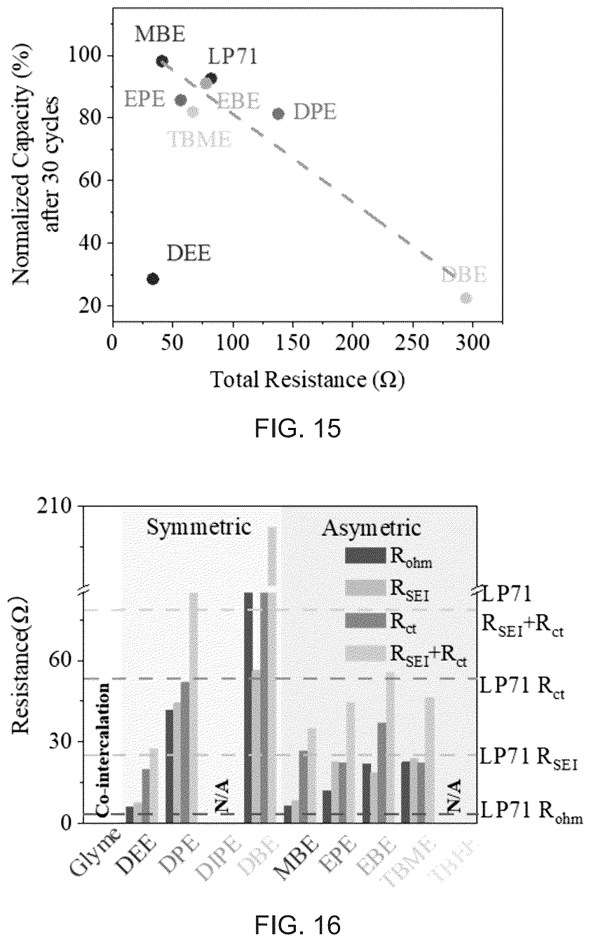

To evaluate the cycling stability, the capacities during cycling are compared in FIG. 15. All cells undergo an SEI formation process before reaching the maximum capacity for this example. Notably, cells with asymmetric SOLE electrolytes can deliver a comparable or even higher capacity than LP71, despite their much lower conductivity than LP71. Such superior performance may be attributed to a low interfacial resistance (FIG. 16 and Table 6).

TABLE 6
Fitting Parameters of the EIS of the Li|Gr Half-cells
(De-lithiated State)

| | | Rₒₕₘ | R_{SEI} | R_{ct} | Sum of R_{SEI} |
|---|---|---|---|---|---|
| Structure | Electrolyte | (Ω) | (Ω) | (Ω) | and R_{ct}(Ω) |
| | LP71 | 3.3 | 25.3 | 53.2 | 78.5 |
| | DME | — | — | — | — |
| Symmetric | DEE | 6.1 | 7.45 | 19.8 | 27.3 |
| solvents | DPE | 41.65 | 44.2 | 51.9 | 96.1 |
| | DIPE | — | — | — | — |
| | DBE | 92.93 | 56.1 | 145 | 201 |
| Asymmetric | MBE | 6.195 | 8.21 | 26.7 | 34.9 |
| solvents | EPE | 12.06 | 22.4 | 22.1 | 44.5 |
| | EBE | 21.83 | 18.7 | 37.1 | 55.8 |
| | TBME | 22.36 | 21.9 | 22.3 | 46.2 |
| | TBEE | — | — | — | — |

Asymmetric SOLE electrolytes show stable cycling. Symmetric SOLE electrolytes show very different behaviors. 1 m LiFSI-DEE suffers from fast capacity decay, which is consistent with its low CE compared to other SOLE electrolytes and may arise from the very low BP of DEE. The DPE and DBE-based electrolytes deliver lower capacity than the other SOLE electrolytes, possibly due to their low conductivities and large Rₒₕₘ. Interestingly, DPE and DBE-based electrolyte show increasing capacity during cycling, which is attributed to a slow SEI formation process and electrolyte filtration process.

To examine if SOLE electrolytes can reduce the interfacial resistances, electrochemical impedance spectroscopy (EIS) of Li|Gr cells was collected and fitted with an equivalent circuit model to obtain Rₒₕₘ, R_{SEI} and R_{ct}. Two semi-cycles were identified in the spectra, in which the high-frequency semi-cycle corresponds to the migration of Li⁺ through SEI and the low-frequency semi-cycle corresponds to the charge transfer reaction. By comparing Rₒₕₘ, R_{SEI} and R_{ct} of SOLE electrolytes and LP71, three conclusions can be drawn: (1) Regarding Rₒₕₘ, SOLE electrolytes exhibit higher Rₒₕₘ than LP71, consistent with their lower conductivity; (2) Regarding R_{SEI}, electrolytes based on SOLEs with shorter alkyl groups exhibit lower R_{SEI} than LP71, while electrolytes based on SOLEs with longer alkyl groups show higher R_{SEI}. This is likely because the short-chained lithium alkoxide, a main component of SEI generated due to the decomposition of SOLEs, has higher Li conductivity than long-chained lithium alkoxide. Asymmetric SOLE electrolytes have lower R_{SEI} than LP71, especially MBE electrolyte. (3) Regarding R_{ct}, SOLE electrolytes, except for DBE, have a lower R_{ct} than LP71. Such a difference may arise because SOLEs form much weaker binding with Li⁺ than the more polar EC.

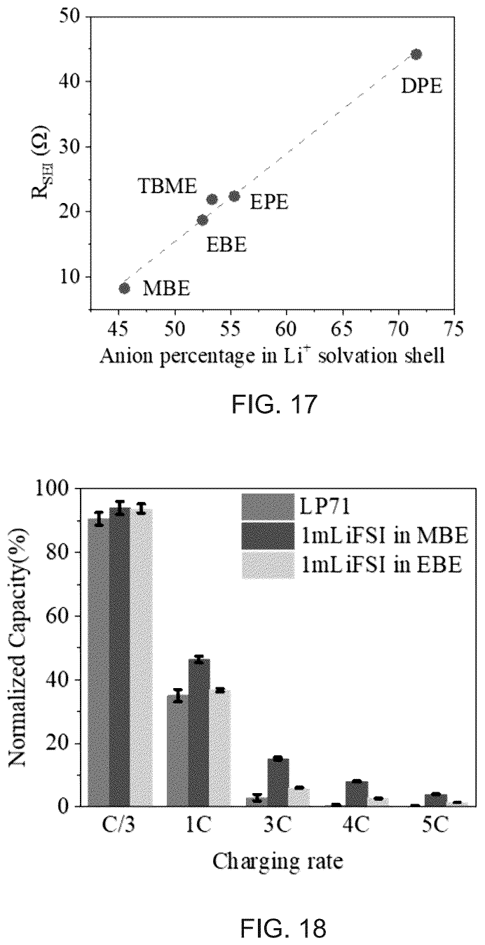

The formation of the SEI can be influenced by the structure of the electrolyte. A less polar solvent results in a Li⁺ solvation structure with fewer solvent molecules and more anions in its solvation shell. FIG. 17 illustrates a relationship between the percentage of anions in the Li⁺ solvation shell and R_{SEI}. It can be interpreted as, basically, FSI⁻ are favored to be reduced rather than the ether solvent to generate the stable SEI film. With more anions in the solvation shell, more anions will be reduced to generate the SEI film at the same time with Li⁺ intercalation into graphite, which induces a higher R_{SEI}. No clear relationship between R_{ct}, Rₒₕₘ, and the anion percentage was observed.

Summarizing the Li|Gr results, among SOLE electrolytes, MBE electrolyte shows the highest average CE and the second lowest interfacial resistance (R_{SEI}+R_{ct}). EBE shows the highest BP, and its electrolyte shows the highest initial CE and much lower resistance than LP71. Meanwhile, both can support the stable cycling of graphite in Li|Gr cells and deliver higher capacity than other SOLE electrolytes. Therefore, MBE and EBE electrolytes are selected to examine whether SOLE electrolytes can enhance the charging and low-temperature performance in Li|Gr half-cells, as discussed in the next section.

The capacities of Li|Gr cells at different charging rates were compared in FIG. 18. The cells were charged (lithiation) at different rates and discharged (de-lithiation) at a C/3 rate. The cells with MBE and EBE electrolytes deliver higher capacity than the cell with LP71 at any charging rate. In addition, low-temperature charging experiments were conducted at −20° C. The cells with MBE and EBE electrolytes exhibit a significantly higher capacity than the cell with LP71. The superior performance is attributed to the low MP of SOLE and low interfacial resistances of MBE and EBE electrolytes, highlighting their potential in enabling fast-charging and low-temperature LIBs.

To elucidate the origin of low R_{ct} of the MBE electrolyte, the activation energy of R_{ct} of 1 m LiFSI-MBE was computed based on EIS results at different temperatures. The cell was first activated by charge/discharge at C/3 for three cycles, and then the EIS was collected at different temperatures. The R_{ct} is obtained by fitting the EIS results with the equivalent circuit. Based on the previously reported method, log (R_{ct}) at different temperatures was plotted against 1000/T. According to

$$\frac{1}{{R}_{ct}} = {Ae}^{( - \frac{{E}_{a}}{R T} )} ,$$

in which A is the pre-exponential factor, Eₐ is the activation energy of R_{ct}, in which the de-solvation energy is the major energy-consuming step, R is the gas constant, and T is the temperature. The activation energy of MBE electrolyte is computed to be 26.3 kJ/mol, which is significantly lower than the activation energy of EC-based electrolytes (50-70 kJ/mol). Such a very low activation energy suggests the weak binding between Li⁺ and MBE and it explains the low R_{ct}.

To examine the SEI formation mechanism in SOLE electrolytes, cyclic voltammetry (CV) of Li|Gr cells was performed. For LP71, a distinct reduction peak at 0.6 V is observed during the first cathodic scan, corresponding to the reduction of carbonates. In contrast, for MBE electrolyte, a reduction peak at ˜1.1 V is observed during the first cathodic scan, corresponding to the reduction of FSI⁻. Similar reduction peak was also observed in other SOLE electrolytes. These results confirm that the SEI in SOLE electrolytes is dominated by anion decomposition. However, for 1 m LiFSI-EC/DEC/DMC, the reduction peak appears at approximately 0.6 V, which is similar to LP71. This finding suggests that, even with the substitution of LiPF₆ by LiFSI, carbonate is still the primary reactant for the formation of SEI. The peak lithiation and de-lithiation currents in the 3^{rd} cycle are 1.37 and 1.88 mA/cm² in LP71, respectively. In comparison, in MBE electrolyte, the peak lithiation and de-lithiation current reach 2.43 and 2.26 mA/cm², respectively, which are 77% and 65% higher than those observed in LP71. This result further demonstrates the faster lithiation and de-lithiation kinetics in MBE electrolyte, despite its lower conductivities.

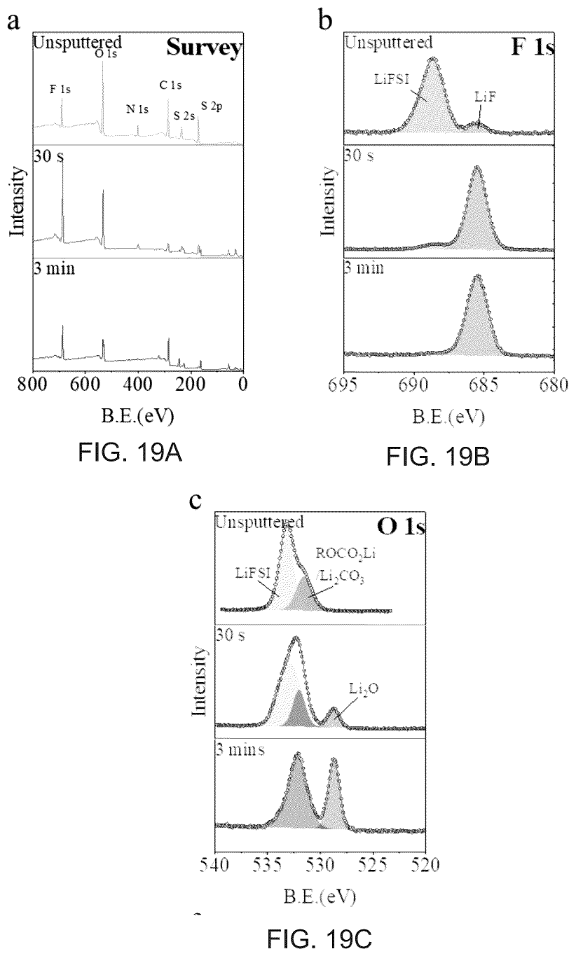

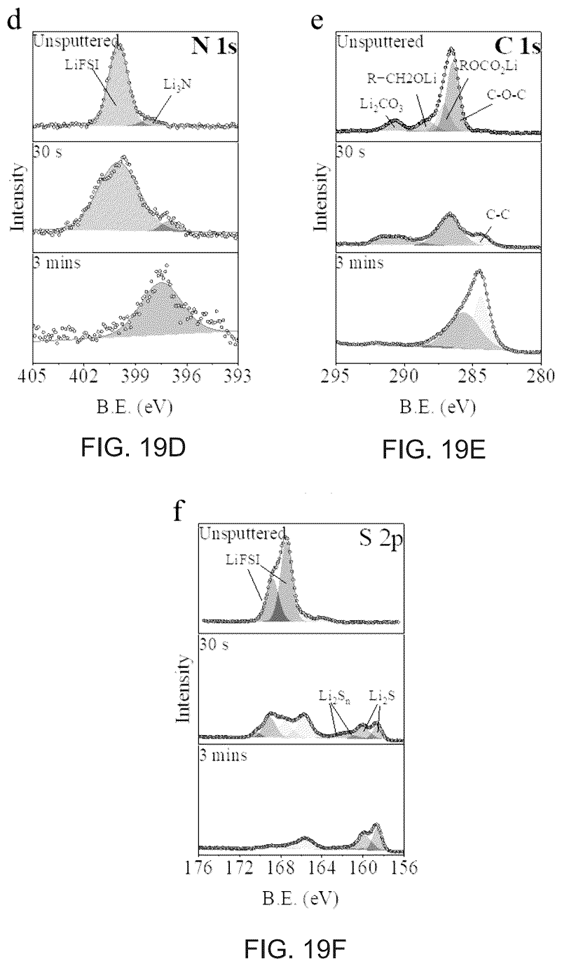

To study the composition of SEI, X-ray photoelectron spectroscopy (XPS) of graphite electrodes cycled in SOLE electrolytes was collected. MBE and DPE were chosen as the representative symmetric and asymmetric SOLEs, respectively. The survey of the unsputtered graphite is shown in FIG. 19A. The high-resolution spectra of each element are given in FIGS. 19B-F and fitted based on literature as summarized in Table 7.

TABLE 7
Binding Energy of Main SEI Components Reported in Literature

| | Binding Energy | | | | |
|---|---|---|---|---|---|
| SEI Component | F 1s | N 1s | S 2p [symbol] | C 1s | O 1s |
| LiFSI | 687.9 ⁹ | 400 ⁹ | 170.3 ⁹ | | 533.2 ⁹ |
| ROCO₂Li | | | | 286-287 ¹⁰ | 531.8 ¹⁰ |
| R—CH2OLi | | | | 288 ¹² | |
| C—O—H/C—O—C | | | | 285.5 ¹⁰ | |
| Li₂CO₃ | | | | 289.8-290.2 ¹⁰ | 531.8 ¹⁰ |
| Li₂O | | | | | 528.7 ¹⁰ |
| LiF | 685.5¹² | | | | |
| Li₃N | | 397.5 ¹² | | | |
| Li₂Sₙ (2 < n < 8) | | | 161.7-163.2^{13,14} | | |
| Li₂S | | | 106.5 ¹² | | |

[symbol]

indicates data missing or illegible when filed

Before sputtering, residual LiFSI and organic decomposition products dominate. After sputtering, significant amounts of inorganic Li salts (LiF, Li₃N, Li₂Sn, Li₂O, and Li₂CO₃) are observed. As shown in Table 8 and Table 9, the F/O ratios in MBE and DPE after 30 s sputtering are 0.84 and 1.43, respectively.

TABLE 8
Atomic Percentage of Different Elements in SEI Generated by DPE

| | Element | | | | |
|---|---|---|---|---|---|
| Sputtering time | F | O | N | S | C |
| Unsputtered | 9.3 | 28.2 | 6.9 | 15.0 | 40.6 |
| 30 s | 28.8 | 20.2 | 2.9 | 9.8 | 38.2 |
| 1 min | 20.0 | 14.9 | 1.9 | 7.9 | 55.2 |
| 3 mins | 9.4 | 8.0 | 1.1 | 4.7 | 76.8 |

These values are much higher than the ratio of F/O=0.23 in commercial carbonate electrolytes, suggesting the high fraction of LiF in the SEI and confirming anion decomposition. Such LiF-rich SEI with mixed Li compounds is found to have good Li⁺ conductivity. Interestingly, the amount of carbon element in the SEI generated in DPE is much higher than that in MBE. This indicates that more solvent molecules decompose during SEI formation in the DPE electrolyte. This difference may be due to the different reduction resistance, which is linked to the structural differences between symmetric and asymmetric SOLEs. In addition, a higher F/O ratio is observed in DPE, suggesting more anion reduction occurs during SEI formation. This is consistent with the fact that more anions are present in the solvation shell in the DPE electrolyte. This also explains the higher R_{SEI} in DPE than in MBE because Li⁺ diffusion is slower in organic salts. In conclusion, due to the unique solvation structure of SOLE electrolytes, FSI⁻ is prone to decompose during initial lithiation, which leads to a LiF-rich SEI that lowers interfacial resistance and improves charging and low-temperature performance.

TABLE 9
Atomic percentage of different elements in SEI generated by MEB

| | Element (%) | | | | |
|---|---|---|---|---|---|
| Sputtering time | F | O | N | S | C |
| Unsputtered | 9.0 | 29.7 | 6.1 | 12.7 | 42.4 |
| 30 s | 28.6 | 33.9 | 5.1 | 14.9 | 17.5 |
| 1 min | 25.7 | 33.3 | 3.7 | 13.8 | 23.6 |
| 3 mins | 14.5 | 21.3 | 2.3 | 10.0 | 51.8 |

Compatibility of SOLE Electrolyte with LFP and NMC Cathode.

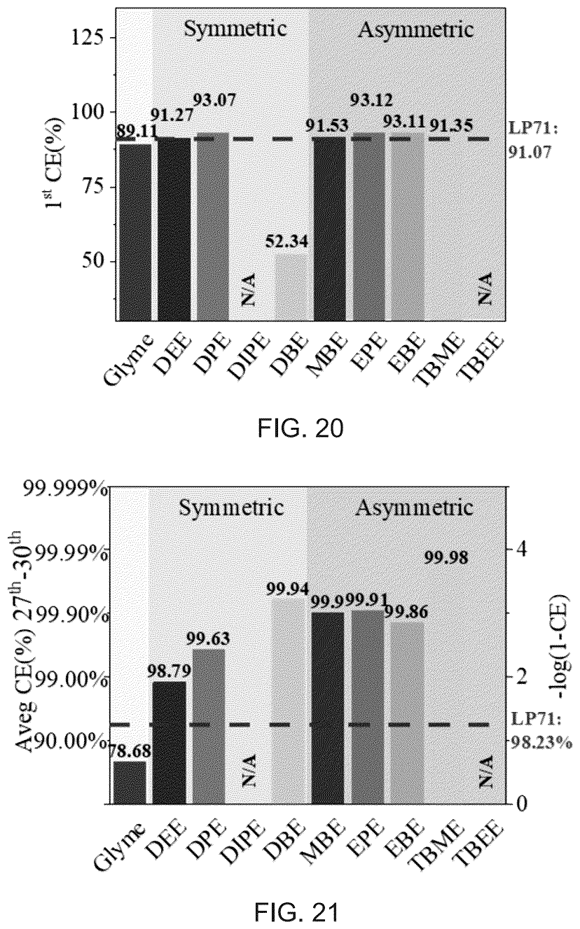

To examine the compatibility of SOLE electrolytes with oxide cathodes, Li|LFP and Li|NMC cells with LP71, Glyme, and SOLE electrolytes were made and charge-discharge cycling (both at C/3 rate) was performed. For LPF cathodes, the voltage range was set as 2.5V-3.8V. As FIGS. 20 and 21 show, commercial electrolyte LP71 (with no additives) displays a 1^{st} CE of 91.07% and an average CE of 98.23%. Glyme electrolyte shows slightly lower 1^{st} CE (89.11%), and the average CE fades rapidly to 78.68% after 30 cycles.

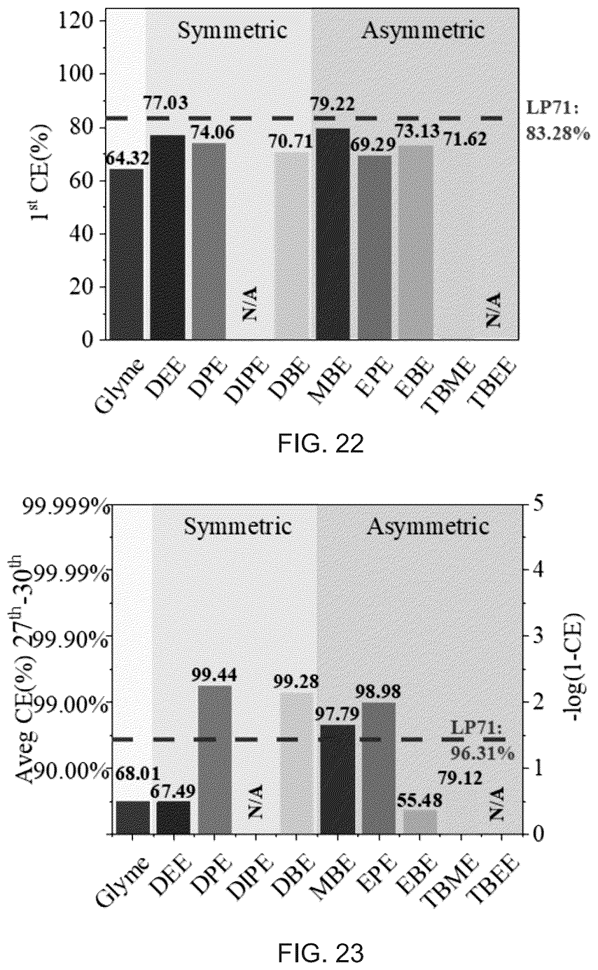

In contrast, SOLE electrolytes, except DBE, show a higher 1^{st} CE and higher average CE than LP71. Noteworthily, EPE shows the best 1^{st} CE (93.12%) and TBME shows the highest average CE (99.98%) among all SOLE electrolytes. Although the 1^{st} CE of DBE is lower than that of LP71, the average CE of DBE gradually rises to 99.94% after 30 cycles. Additionally, SOLE electrolytes, except TBME and DBE, showed comparable cycling performance to LP71. These results indicate that SOLE electrolytes exhibit excellent oxidative stability under 3.8V and are compatible with the LFP cathode. The voltage range for the NMC cathode was set as 3.0-4.1V. The 1^{st} CEs of SOLE electrolytes are less than LP71 (FIG. 22), indicating that SOLE electrolytes are less compatible with NMC cathode due to their low oxidation resistance. Besides, cells which charged to 4.5V were also conducted. However, it is observed that SOLE electrolytes exhibit poor compatibility with the NMC electrode when charged to 4.5V. Despite EPE showing the best average Coulombic efficiency (CE) of 99.5% between the 25th and 30th cycle, this still falls short of a desired long cycle-life requirement, which necessitates a CE above 99.9%. The underlying reason for this issue can be attributed to the weak resistance of the oxidation reaction of the ether solvent. Despite the presence of numerous CIPs and AGGs in the electrolyte, there still remain a significant number of free solvent molecules in the electrolyte, which can gradually undergo oxidation at such high voltages during cycling. Linear Sweep Voltammetry (LSV) using Li|Al coin cells was conducted to investigate the oxidative stability of SOLE electrolytes, with NMC as the working electrode. Within 4.1V, the EPE, MBE, DPE and DBE show a lower current density than other SOLE electrolytes. This may explain why their average CE (FIG. 23) exceeds LP71 after 30 cycles. The higher CE suggests their compatibility with NMC can improve during cycling, possible due to the formation of cathode-electrolyte interphase (CEI). To confirm the existence of CEI, XPS was conducted on the after-cycled NMC electrode in the MBE electrolyte. The analysis reveals the presence of decomposed LiFSI salt on the NMC surface, leading to the formation of LiF and Li₂S. However, the amount of decomposed salt is relatively small, as indicated by the minimal signal for LiN₃. In contrast to the SEI formation on the graphite electrode, which primarily consists of anion decomposition products, CEI on the NMC electrode is predominantly derived from solvent decomposition. This can be observed from the intensity of peaks corresponding to ROCO₂Li, C—O—C, and C—C bonds in the XPS spectrum. The dominance of solvent decomposition products in the CEI can be attributed to the decomposition of ethers, which exhibit higher resistance to reduction but weaker resistance to oxidation.

### Performance of Gr|LFP Full Cells.

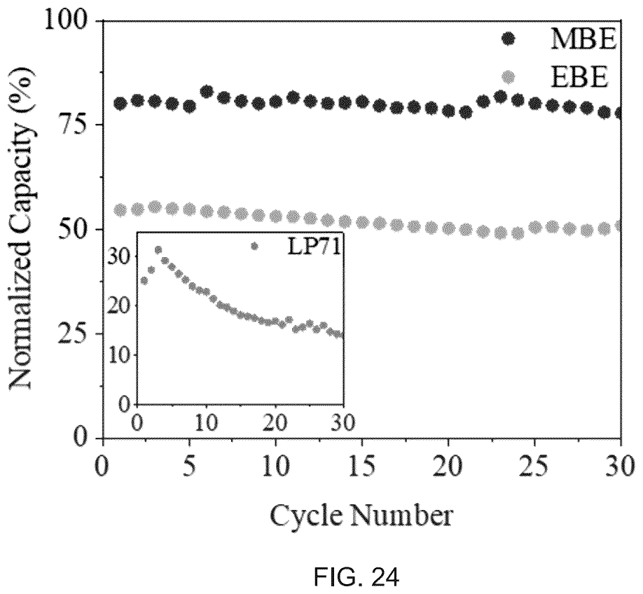

The impressive performance of SOLE electrolytes in Li|Gr and Li|LFP half cells suggests they can be a new generation of electrolytes for 3.4V-LIBs using the LFP cathode. To demonstrate the performance of SOLE electrolytes in Gr|LFP full cells, Gr|LFP cells with LP71, MBE, EBE and EPE electrolytes were made, and their performance was assessed. MBE and EPE demonstrate higher capacity than LP71. Notably, even charged at an 8C rate, Gr|LFP cells with MBE and EPE electrolytes still can deliver 48.1% and 50.3% of capacity, respectively, which are 36.0% and 42.0% more than that of LP71. Under high charging rates, cells with SOLE electrolytes show stable cycling, while cells with LP71 show an apparent capacity fading. Such contrast highlights that SOLE electrolytes can significantly enhance the charging performance without compromising cycling stability. The low-temperature performance of Gr|LFP was compared in FIG. 24, LP71 only delivers 24.9% of its room temperature capacity, whereas MEB electrolyte and EBE electrolyte deliver 78.5% and 52.3% of their room temperature capacity, respectively. In addition, cells with LP71 suffer fast capacity decay when cycled at such a low temperature, whereas there is no sign of capacity fading during the cycling of cells made with MBE and EBE electrolytes.

To examine the long-term compatibility of SOLE electrolytes with LFP and Gr, the 1 C cycling performance of Gr|LFP cells was compared. Cells with SOLE electrolytes exhibit higher capacity retention in the initial 400 cycles than the cells with LP71. EPE-based electrolyte exhibits the best capacity retention of these options, with only 14.1% fading after 500 cycles and 22.7% fading after 1000 cycles. The MBE-based electrolyte also shows better capacity retention than LP71 in 500 cycles, with 18.5% fading after 500 cycles. Both SOLE electrolytes satisfy the Department of Energy's cycling performance target for fast-charging batteries (20% fading for 500 cycles). Gr|LFP cells using MBE electrolyte are also tested under 8 C extreme fast charging conditions, which shows better capacity retention than cells made with LP71. In addition, cells with SOLE electrolytes show higher CE (above 99.5%) than cells with LP71 electrolytes, demonstrating the stability of SOLE electrolytes in Gr|LFP full cells. EIS results were collected (Table 10) before and after 1000 cycles. The relatively poor cycling performance of cells with EBE-based electrolyte can be attributed to the increasing R_{SEI} during cycling, consistent with its relatively low CE on both anode and cathode.

TABLE 10
Fitting Parameters of the EIS of the Gr|LFP Full Cells
(De-lithiated State)

| | | Rₒₕₘ | R_{SEI} | R_{ct} | Sum of R_{SEI} |
|---|---|---|---|---|---|
| Electrolyte | | (Ω) | (Ω) | (Ω) | and R_{ct}(Ω) |
| MBE | Before | 7.09 | 17.5 | 47.3 | 64.8 |
| | After | 29.1 | 22.7 | 46.6 | 69.3 |
| EBE | Before | 20.7 | 18.67 | 37.1 | 55.77 |
| | After | 22.8 | 75.4 | 42.5 | 117.9 |
| EPE | Before | 12.06 | 22.4 | 23.9 | 46.3 |
| | After | 8.8 | 24.6 | 26.1 | 50.7 |

In summary, the results demonstrate that SOLE electrolytes show promise as a family of electrolytes for enhancing the performance of Gr|LFP LIBs, particularly in terms of charging and low-temperature performance. The excellent capacity retention of Gr|LFP cells with MBE and EPE electrolytes at high charging rates and low temperatures highlights the superiority of these electrolytes over LP71. Additionally, the remarkable capacity retention and stability observed in long-term cycling of cells with EPE electrolyte indicate its potential for prolonged use in Gr|LFP LIBs.

The following conclusions can be drawn from the results of the experimental examples described above. First, symmetric SOLEs, characterized by lower polarity, tend to exhibit a higher percentage of AGG-II in the electrolyte than asymmetric SOLEs. Second, asymmetric SOLE solvent has more polarity than symmetric SOLE, which causes higher conductivity. However, the steric effect also affects the salt dissociation. For example, TBME has a higher dipole than MBE, but its conductivity is lower than MBE. Regarding interfacial resistance, electrolytes made with asymmetric solvents typically exhibit lower values of R_{SEI} and R_{ct} compared to their symmetric counterparts. Third, cells made with asymmetric SOLEs can have a higher CE and capacity retention than cells made with symmetric SOLEs.

Despite belonging to the same ethereal solvent family (having the same —O— functional group), SOLEs do not co-intercalate with Li⁺ into graphite, whereas Glyme does. This unique property is due to the peculiar electrolyte structure of SOLE electrolytes compared to that of the Glyme electrolyte. SOLEs are unable to dissociate the dissolved Li salts fully. Consequently, there is a high fraction of ion pairs and aggregates in SOLE electrolytes, which despite compromising electrolyte conductivity, results in an anion-dominated Li⁺ solvation shell. The anions in such solvation shells are susceptible to reduction during battery charging because the coordination with Li⁺ shifts their LUMO downward. Consequently, a SEI that is rich in anion-dominated products is formed, in which the outer layer mainly consists of the organic component and the inner layer are mainly made of inorganic salt (LiF, LiO₂, LiN₃ and LiSₓ). This SEI can effectively passivate the graphite anode, prevent solvent co-intercalation, and dramatically reduce SEI resistance. Compared to the commercial carbonate electrolyte (LP71 as the example in the tests described above), in which EC is a component that enables a stable SEI on the graphite anode, SOLE electrolytes rely on the decomposition of FSI⁻ anion to form a stable SET. Such a SEI shows a much lower R_{SEI} than that formed in the commercial carbonate electrolyte because of the generation of LiF-rich SET. Substituting LiFSI with other salts would not achieve the same because other salt cannot generate a stable SET. Combined with the low charge transfer resistance due to the weak anion-Li⁺ binding, SOLE electrolytes significantly reduce the interfacial resistance compared to commercial carbonate electrolytes.

The better cathodic stability of ethereal solvents compared to EC is usually not an advantage when designing Li-ion battery electrolytes, because solvent co-intercalation occurs before electrolyte decomposition. In the case of SOLEs, however, the anion-dominated Li⁺ solvation shell favors anion decomposition, which enables the formation of a stable SEI on graphite anode. This is due to the weak solvating power of SOLEs, which is rooted in their unique molecular structure. First, SOLEs have lower polarity compared to Glyme or other commonly used ether solvents (such as triglyme, tetraglyme etc.). The polarity of linear ether solvent depends on the C/O ratio, because the C—C bond is non-polar, whereas the C—O bond is polar. SOLEs in the examples above have C/O ratios greater than 4, whereas Glyme has a C/O ratio of 2. Second, SOLEs can be mono-dentate solvents with only one O atom. In contrast, commonly used ether solvents (including Glyme) have more than one oxygen atom and are multi-dentate. The chelating effect makes their binding with Li⁺ much stronger than SOLEs, which is around 40-107.7 kcal/mol.⁷¹ For diglyme and triglyme, which have 3 and 4 oxygen atoms that matches well with the Li⁺ coordination number, long-lived complexes can even form. Thirdly, steric hindrance can further weaken the solvating power of SOLEs. Ether with bulky alkyl groups tends to have worse solvating power. For example, MTBE has a weaker solvating power than MBE because the tert-butyl group introduces extra steric hindrance.

It is worth noting that the Li solvation structure of the SOLE electrolytes described above is similar to that of concentrated electrolytes but for very different reasons. In a normal 1 mol/kg electrolyte based on a polar solvent with strong solvating power, salts can be fully dissociated so that Li⁺ is solvated by solvent molecules to form solvent separated ion pairs. In 1 mol/kg SOLE electrolytes, there is a high population of CIPs and AGGs due to the inadequacy of the solvent to dissociate the Li salt and solvate Li⁺. In contrast, concentrated electrolyte has high population of CIPs and AGGs simply because there are not enough solvent molecules to dissociate Li salt and coordinate Li⁺ due to the high salt/solvent ratio. The structural similarity leads to common features shared by both systems, including anion-derived SEI, low degree of ion dissociation (therefore, low conductivity). The anion-derived SEI is made of mostly inorganic components. This anion-derived SEI has a lower R_{SEI} than the solvent-derived SEI (The R_{SEI} in the examples above were 5.8 Ω·cm² in MBE vs. 17.9 Ω·cm² in LP71), which includes a two-layer structure with the top layer being organic.

However, there are clear differences. Due to the low salt concentration (and thereby the presences of free solvent molecules), SOLE electrolytes have distinctive features that are not offered by concentrated electrolytes, such as low viscosity, good wettability and low cost. In addition, SOLE electrolytes have low R_{ct} due to the low de-solvation energy (the de-solvation energy for 4.5 M LiFSI in AN is about 59.63 kJ/mol). On the other hand, the concentrated electrolyte has better anodic stability because most solvent molecules are coordinated with Li⁺ and such coordination shifts their highest occupied molecular orbital (HOMO) downward.

Despite SOLE electrolytes and HCE both having low conductivity, the mechanisms may be quite different. In SOLE electrolytes, there are large amounts of free solvent molecules due to the low salt concentration (and high solvent/Li ratio: 13.5-9.79 in the examples above). Consequently, the CIP and AGGs are local features, and they are separated by free solvent molecules and thereby do not form long-range peculated structures. Therefore, Li⁺ conduction occurs mostly by vehicular mechanism, i.e., the vehicular motion of the solvated Li⁺ with a net charge. In this regard, CIPs are not charge carriers and do not contribute to conductivity. The low conductivity is mainly due to the low concentration of charge carriers. In the case of HCE, there are no free solvents and the CIP/AGG form a long-range percolated network, so ion conduction occurs in a more structural mechanism. One such structural mechanism is the hopping mechanism, which is similar to the Grotthuss mechanism of proton transport in aqueous solutions and is observed for systems in which solvent binds two or more Li⁺ in the concentrated electrolyte. Such hopping involves the solvent and/or anion bridging two or more Li⁺, the spatial proximity of coordination sites (high salt concentration), along with the possible domain structure.

Another intriguing property of the SOLE electrolytes is that they enable better rate performance than LP71 despite their significantly lower conductivity (LP71: 13.3 mS/cm; MBE: 0.956 mS/cm). This can be partially explained by the remarkably lower interfacial resistance (R_{ct}+R_{SEI}) (LP71: 55.6 Ω·cm²; MBE: 24.7 Ω·cm²), which compensates for the large ohmic resistance and leads to a lower overall resistance (Rₒₕₘ+R_{ct}+R_{SEI}) (LP71: 57.9 Ω·cm²; MBE: 29.1 Ω·cm²). Such a low overall resistance appears to be responsible for the high-power performance of a short charge/discharge pulse. In this scenario, the Li⁺ concentration gradient in the liquid electrolyte in the thickness direction is small or negligible, so ohmic and interfacial overpotentials dominate the internal polarization of cells. Consequently, a low overall resistance (Rₒₕₘ+R_{ct}+R_{SEI}) enables high pulse power, and the maximum pulse power scales with V²/R, in which V is cell voltage and R is the overall cell internal resistance. For an extended charge/discharge operation, the Li⁺ concentration gradient in the liquid electrolyte in the thickness direction becomes significant, especially in thick electrodes, so concentration overpotential dominates. In this scenario, fast diffusion of Li-containing species can allow one to achieve high average power. The maximum average power scales with VCD_{eff}/L², in which V is the cell voltage, C is the cell capacity, L is the distance between cathode and anode current collectors, and D_{eff} is the effective diffusivity of the Li-containing species in the tortuous pores of battery electrodes. In the literature, it is generally believed that high conductivity is desirable to achieve high power performance. However, the low total internal resistance (Rₒₕₘ+R_{ct}+R_{SEI}) determines the maximum pulse power, and the diffusivity of Li-containing species determines the maximum average power (especially for thick electrodes). The higher power of SOLE electrolytes than LP71 is a synergy of low overall resistance and high diffusivity of Li-containing species.

Based on the results and the above discussion, the unique properties of SOLE electrolytes are summarized. First, regarding bulk transport properties, SOLE electrolytes have low viscosity and high diffusivity due to the large number of free solvents but low conductivity due to low salt dissociation. Second, regarding interfacial properties, SOLE electrolytes have low interfacial resistance (R_{SEI}+R_{ct}) due to their anion-derived SEI and weak solvent-Li⁺ binding. Thirdly, SOLE electrolytes have a low melting point, beneficial for low-temperature performance. Lastly, SOLE electrolytes are compatible with the low-voltage cathode (LFP).

### Materials Used

Lithium bis(fluorosulfonyl)imide (LiFSI) was purchased from Gotion, Inc. (Fremont, CA, USA). 1 M LiPF₆ in 1:1:1 EC/DMC/DEC in wt % (LP71) were purchased from Sigma Aldrich. Solvents, including DEE, DBE, DPE, DIPE, MBE, EPE, and EBE, were purchased from Sigma Aldrich and Tokyo Chemical Industry Ltd. All solvents were treated with a 3 Å molecular sieve to reduce moisture to below 20 ppm. The SOLE electrolytes were prepared in an argon-filled glove box (O₂ content below 5 ppm, water content below 0.05 ppm) by dissolving LiFSI salt into the solvents.

Lithium disks with a thickness of approximately 45 m were used. The graphite electrode, purchased from MTI Corp., had a loading of 2.0 mAh/cm². The NMC532 and LFP electrodes, obtained from Argonne National Laboratory, had loadings of 1.58 mAh/cm² and 1.88 mAh/cm², respectively. All electrodes were cut into ⅜-inch diameter disks and dried in a vacuum oven at 120° C. for 24 hours.

### Electrochemical Tests

All experiments were conducted using 2023-type coin cells with Celgard 2400 as the separator and 80 μl of electrolyte. Prior to electrochemical testing, all half-cells were pre-treated by undergoing three cycles of solid electrolyte interphase (SEI) formation at C/3 rate (based on the working electrode loading) at room temperature. For the Li|Gr half-cell cycling, the C/3 rate charging and discharging protocol was used within the voltage range of 0.005-0.6 V. For rate performance testing of Li|Gr, cells were charged at different rates and discharged at the C/3 rate. For low temperature testing of Li|Gr, cells were soaked in a low-temperature thermostatic bath to maintain at −20° C., and were charged using C/3 constant current constant voltage (CCCV) protocol with C/20 of current cut-off. For the Li|LFP and Li|NMC532 cells, cycling was performed at 2.5-3.8V and 3-4.1 V at C/3 rate, respectively. For the Gr|LFP full cell, in which the N:P ratio is 1.06, cycling tests, cells were cycled using the 1 C CCCV protocol with a 1-hour time control at 30° C. between 2.5-3.6V. For low-temperature testing of the Gr|LFP full cell, cells were first pre-cycled at room temperature in C/3, then charged using C/3 CCCV protocol at −20° C.

Electrochemical impedance spectroscopy (EIS) tests were conducted using a Gamry Interface 1010T at 25° C. Prior to the EIS measurements, all batteries underwent three cycles of charging and discharging at C/3 rate and were then rested for 2 hours to reach equilibrium. For EIS measurements at different temperatures, cells were held at the desired temperature for 1 hour before testing. Conductivity was measured using a Mettler Toledo F3-Field FiveGo Portable Conductivity meter, which was pre-calibrated using the 1413 μS/cm conductivity standard solution at 25° C. Linear scan voltammetry (LSV) stability tests were conducted by 2023-type coin cells made by 45 μm Li and Al foil with scan rate 1 mV/s.

### Characterization

Thermogravimetric analysis (TGA) was conducted by a thermogravimetric analyzer (SDT 650, TA Instruments) under a nitrogen atmosphere ranging from 30 to 300° C. with a heating rate of 10° C./min. Raman spectrum measurements were conducted on WiTec AlphaSNOM™ with a 488 nm excitation laser for the liquid electrolytes sealed in tubes. X-ray photoelectron spectroscopy (XPS) and argon sputtering were done by Kratos Axis Ultra DLD. Graphite electrodes were transferred through the antechamber to avoid any air contact. An area of 300 μm×700 μm was irradiated using a filament voltage of 15 kV, an emission current of 8 mA, and a pass energy of 40 eV for high-resolution scans and 160 eV for the low-resolution survey scans. For the XPS sputter depth profiling measurements, a sputter crater of 3 mm×3 mm area was produced by the Ar⁺ ion beam using an emission current of 20 mA and a filament voltage of 4 kV. The XPS spectra were calibrated by referencing sp² carbon to 284.0 eV. XRD patterns were obtained from a Bruker D2 Phaser with Cu Kα radiation (λ=1.5406 Å).

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A lithium ion battery, comprising:
a cathode;
an anode allowing reversible intercalation of lithium ions into the anode; and
a liquid electrolyte in contact with the cathode and the anode, wherein the liquid electrolyte comprises a single-oxygen linear ether solvent and a lithium salt at least partially dissolved in the solvent, wherein the lithium salt comprises a sulfur-fluorine bond.

2. The lithium ion battery of claim 1, wherein the cathode comprises lithium iron phosphate (LFP), lithium nickel manganese cobalt oxide (NMC), lithium cobalt oxide (LiCoO₂), lithium manganese oxide (LiMn₂O₄), lithium nickel cobalt aluminum oxide (NCA), or a combination thereof.

3. The lithium ion battery of claim 2, wherein the cathode comprises LiFePO₄.

4. The lithium ion battery of claim 1, wherein the anode comprises graphite.

5. The lithium ion battery of claim 1, wherein the anode comprises a solid electrolyte interphase comprising LiF.

6. The lithium ion battery of claim 1, wherein the single-oxygen linear ether solvent is asymmetric.

7. The lithium ion battery of claim 1, wherein the single-oxygen linear ether solvent includes from 4 to 8 carbon atoms.

8. The lithium ion battery of claim 1, wherein the single-oxygen linear ether solvent is selected from the group consisting of: methyl butyl ether (MBE), ethyl propyl ether (EPE), ethyl butyl ether (EBE), tert-butyl methyl ether (TBME), tert-butyl ethyl ether (TBEE), and combinations thereof.

9. The lithium ion battery of claim 1, wherein the lithium salt is lithium bis(fluorosulfonyl)imide, lithium (fluorosulfonyl)(trifluoromethanesulfonyl)imide, lithium fluorosulfonyl)(pentafluoroethanesulfonyl)imide, lithium trifluoromethanesulfonate, or a combination thereof.

10. The lithium ion battery of claim 1, wherein the lithium salt is present at a concentration from about 0.5 mol/kg to about 3 mol/kg with respect to a total weight of the liquid electrolyte.

11. The lithium ion battery of claim 1, further comprising a separator between the cathode and the anode.

12. A liquid electrolyte for a lithium ion battery, comprising:
a single-oxygen linear ether solvent selected from the group consisting of: methyl butyl ether (MBE), ethyl propyl ether (EPE), ethyl butyl ether (EBE), tert-butyl methyl ether (TBME), tert-butyl ethyl ether (TBEE), and combinations thereof; and
a lithium salt at least partially dissolved in the solvent, wherein the lithium salt comprises a sulfur-fluorine bond.

13. The liquid electrolyte of claim 12, wherein the lithium salt is lithium bis(fluorosulfonyl)imide, lithium (fluorosulfonyl)(trifluoromethanesulfonyl)imide, lithium fluorosulfonyl)(pentafluoroethanesulfonyl)imide, lithium trifluoromethanesulfonate, or a combination thereof.

14. The liquid electrolyte of claim 12, wherein the lithium salt is present at a concentration from about 0.5 mol/kg to about 3 mol/kg with respect to a total weight of the liquid electrolyte.

15. A method of using a lithium ion battery comprising charging or discharging the lithium ion battery, wherein the lithium ion battery comprises:
a cathode;
an anode allowing reversible intercalation of lithium ions into the anode; and
a liquid electrolyte in contact with the cathode and the anode, wherein the liquid electrolyte comprises a single-oxygen linear ether solvent and a lithium salt at least partially dissolved in the solvent, wherein the lithium salt comprises a sulfur-fluorine bond.

16. The method of claim 15, further comprising forming a solid electrolyte interphase comprising LiF on the anode.

17. The method of claim 16, wherein forming the solid electrolyte interphase comprises charging and discharging the lithium ion battery multiple times.

18. The method of claim 15, wherein the charging or discharging is performed at a temperature from −25° C. to −10° C.

19. The method of claim 15, wherein the charging is performed at a charge rate from about 4 C to about 8 C.

20. The method of claim 15, wherein the anode comprises graphite, wherein the single-oxygen linear ether solvent is selected from the group consisting of: methyl butyl ether (MBE), ethyl propyl ether (EPE), ethyl butyl ether (EBE), tert-butyl methyl ether (TBME), tert-butyl ethyl ether (TBEE), and combinations thereof, and wherein the lithium salt is lithium bis(fluorosulfonyl)imide, lithium (fluorosulfonyl)(trifluoromethanesulfonyl)imide, lithium fluorosulfonyl)(pentafluoroethanesulfonyl)imide, lithium trifluoromethanesulfonate, or a combination thereof.
